(19) United States
(12) Patent Application Publication
(10) Pub. No.: US 2025/0383908 A1
(43) Pub. Date: Dec. 18, 2025

(54) EPHEMERAL DATACENTER

(71) Applicant: Cisco Technology, Inc., San Jose, CA (US)

(72) Inventors: Edgar Francisco Magana Perdomo, Danville, CA (US); John Zhen Sun, Old Toongabbie (AU); Mit Suthar, Parramatta (AU)

(21) Appl. No.: 18/925,201

(22) Filed: Oct. 24, 2024

Related U.S. Application Data
(60) Provisional application No. 63/659,495, filed on Jun. 13, 2024.

(51) Int. Cl. G06F 9/455

(52) U.S. Cl. CPC G06F 9/45558; G06F 2009/4557; G06F 2009/45595

(57) ABSTRACT

A method for virtual datacenter deployment includes initializing, at a physical datacenter, a virtual private cloud executing one or more containers, and deploying, to a container in the virtual private cloud, a datacenter agent for managing a virtual datacenter executing within the container. The method further includes receiving, from the datacenter agent, a first request for service configuration data defining one or more services provided by the virtual datacenter, and responsive to the first request, providing the service configuration data to the datacenter agent to configure the one or more services provided by the virtual datacenter. The method further includes receiving, from the datacenter agent, a second request for application configuration data defining one or more applications executing within the virtual datacenter, and responsive to the second request, providing the application configuration data to the datacenter agent to configure the one or more applications executing within the virtual datacenter.

This application claims the benefit of U.S. Provisional Application No. 63/659495, filed on June 13, 2024, and which is incorporated herein in its entirety.

### TECHNICAL FIELD

The present disclosure generally relates to datacenters, and more particularly to ephemeral multi-substrate cloud-native datacenters.

### BACKGROUND

Continuous integration and continuous delivery (CI/CD) is a set of practices that enables the software development life cycle (SDLC) process. By automating the software delivery process, CI/CD helps to speed up the time it takes to deploy new features and fix bugs while improving the quality of software by shifting left and by making it easier to roll back changes, when necessary, without human intervention.

However, there is no single software solution that provides all these features fully integrated with a code versioning system. Accordingly, operators typically resort to using a mix of multiple technologies and applications that became a critical path to production.

Cloud datacenters are multi-tenant compute systems designed to host software artifacts for a long period of time. These datacenters should provide fault-tolerance, high availability, and disaster recovery features with zero downtime of the hosted artifacts and minimal impact to their customers.

### SUMMARY

Some embodiments of the present disclosure provide a method for virtual datacenter deployment. The method includes initializing, at a physical datacenter, a virtual private cloud executing one or more containers, and deploying, to a particular container in the virtual private cloud, a datacenter agent for managing a virtual datacenter executing within the particular container. The method further includes receiving, from the datacenter agent, a first request for service configuration data defining one or more services provided by the virtual datacenter, and responsive to the first request, providing the service configuration data to the datacenter agent to configure the one or more services provided by the virtual datacenter. The method further includes receiving, from the datacenter agent, a second request for application configuration data defining one or more applications executing within the virtual datacenter, and responsive to the second request, providing the application configuration data to the datacenter agent to configure the one or more applications executing within the virtual datacenter.

Some embodiments of the present disclosure provide a non-transitory computer-readable medium storing a program for virtual datacenter deployment. The program, when executed by a computer, configures the computer to initialize, at a physical datacenter, a virtual private cloud executing one or more containers, and deploy, to a particular container in the virtual private cloud, a datacenter agent for managing a virtual datacenter executing within the particular container. The program, when executed by a computer, further configures the computer to receive, from the datacenter agent, a first request for service configuration data defining one or more services provided by the virtual datacenter, and responsive to the first request, provide the service configuration data to the datacenter agent to configure the one or more services provided by the virtual datacenter. The program, when executed by a computer, further configures the computer to receive, from the datacenter agent, a second request for application configuration data defining one or more applications executing within the virtual datacenter, and responsive to the second request, provide the application configuration data to the datacenter agent to configure the one or more applications executing within the virtual datacenter.

Some embodiments of the present disclosure provide a system for virtual datacenter deployment. The system comprises a processor and a non-transitory computer-readable medium storing a set of instructions, which when executed by the processor, configure the system to initialize, at a physical datacenter, a virtual private cloud executing one or more containers, and deploy, to a particular container in the virtual private cloud, a datacenter agent for managing a virtual datacenter executing within the particular container. The instructions, when executed by the processor, further configure the system to receive, from the datacenter agent, a first request for service configuration data defining one or more services provided by the virtual datacenter, and responsive to the first request, provide the service configuration data to the datacenter agent to configure the one or more services provided by the virtual datacenter. The instructions, when executed by the processor, further configure the system to receive, from the datacenter agent, a second request for application configuration data defining one or more applications executing within the virtual datacenter, and responsive to the second request, provide the application configuration data to the datacenter agent to configure the one or more applications executing within the virtual datacenter. Providing the service configuration data to the datacenter agent includes retrieving the service configuration data from a services code repository, and providing the application configuration data to the datacenter agent includes retrieving the application configuration data from an application code repository.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement virtual datacenters, according to some embodiments.

FIG. 2 is a block diagram illustrating details of a system for provisioning virtual datacenters, according to some embodiments.

FIG. 3 is a flowchart illustrating a process for virtual datacenter deployment, according to some embodiments.

FIG. 4 is a block diagram illustrating a cloud infrastructure, according to some embodiments.

FIG. 5 is a block diagram illustrating an exemplary computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “GitOps” as used herein refers, according to some embodiments, to an operational framework that applies software development practices like version control, code review, and continuous integration/continuous delivery (CI/CD) to infrastructure automation. GitOps uses a Git repository as the single source of truth for defining and managing infrastructure configurations as code. Changes to infrastructure are implemented through pull requests, which undergo peer review and automated testing before being merged and automatically deployed to target environments, ensuring consistency, traceability, and auditability of infrastructure state.

The term “ephemeral datacenter” as used herein refers, according to some embodiments, to a cloud-based datacenter that may be provisioned on demand and automatically de-provisioned when no longer needed.

The term “container” as used herein refers, according to some embodiments, to lightweight, standardized packages of software that encapsulate an application or service along with its dependencies, libraries, and configuration files. This technology allows applications and services to run consistently across various computing environments, such as local machines, data centers, and cloud platforms. Service containerization can include, but are not limited to, microservices, web services, databases, and caching services.

Service containers may be used in a CI/CD pipeline, especially with regard to testing and deployment. As examples, containerized services can be spun up quickly for integration testing, ensuring that tests run in an environment that closely matches production. Services packaged as containers can be easily deployed to various environments, maintaining consistency across development, staging, and production.

The term “pod” as used herein refers, according to some embodiments, to a group of one or more containers that are deployed together on the same host. These containers share resources and are tightly coupled, functioning as a single unit. A pod may run a single main container but can also include helper containers that support the primary application or service. Containers within a pod may share some or all of a network namespace, storage resources, and compute resources. Accordingly, pods are advantageous for deploying individual components of a microservices architecture.

There is a need for integrated CI/CD software solutions for deployment of cloud datacenters. Embodiments of the present disclosure address the above identified problems using GitOps for extending and enhancing the software development life cycle (SDLC) for large-scale production cloud applications, such as deployment of cloud datacenters.

Some embodiments provide Continuous Integrations (CI) pipeline extensions in a pure cloud-native way seamlessly integrated with a code versioning system and the Continuous Delivery enhancements. This provides a full cloud-native orchestration and GitOps experience for Development, Quality Assurance, and Performance teams. Some embodiments extend the GitLab CI/CD capabilities by providing the ability to orchestrate, build and manage service interdependencies and integrations with other systems and enhanced metrics-based service rollouts in a multi-region cloud architecture.

Some embodiments use a CI/CD model (e.g., GitOps) to build and operate cloud-native multi-substrate cloud datacenters. In this context, multi-substrate refers to being agnostic as to which cloud provider the ephemeral datacenter is provisioned to. Cloud-native refers to using cloud services such as containers to execute applications and provide services, and a container management protocol (e.g., Kubernetes, Elastic Container Service, etc.) to manage those containers.

The model of some embodiments uses a seeded portable software (e.g., a seed application) that creates the basic functionality to self-build and operate a datacenter in any cloud provider.

For example, the model may configure on the cloud platform one or more of (a) a temporal and disposable control plane system, (b) a GitOps based control plane system, and/or (c) a tertiary data plane and supporting infrastructure for the ephemeral datacenter.

The GitOps model provides the ability to distribute software artifacts across these ephemeral datacenters providing zero downtime and no impact to customer experience, minimizing the cost of the infrastructure.

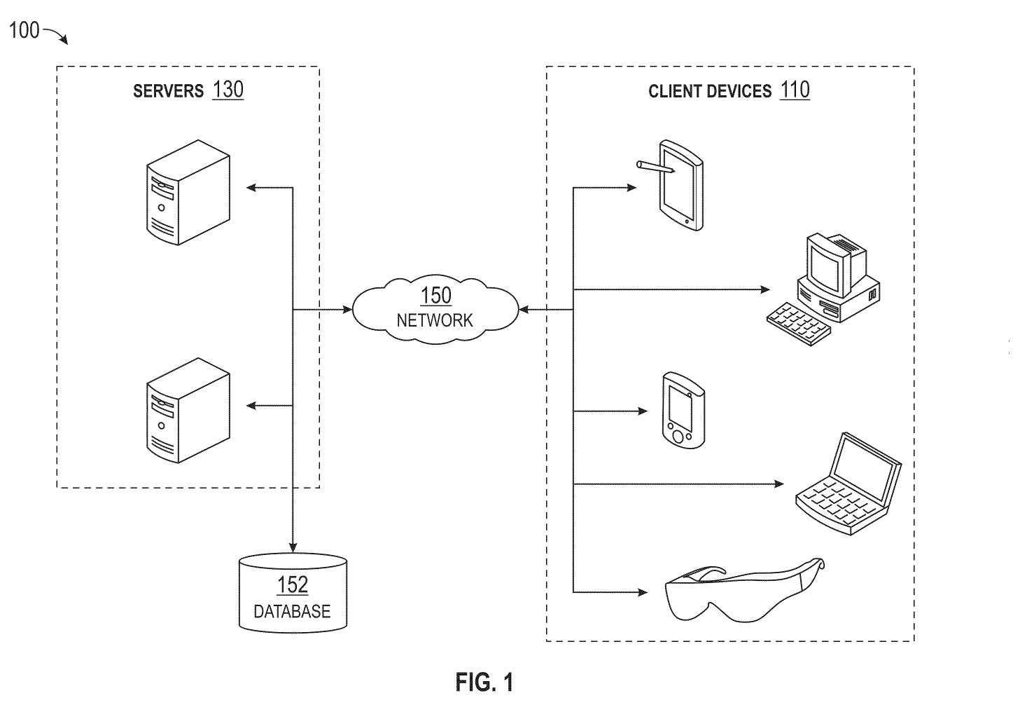

FIG. 1 illustrates a network architecture 100 used to implement virtual datacenters, according to some embodiments. The network architecture 100 may include one or more client devices 110 communicatively coupled with one or more servers 130 via a network 150. The client devices 110 and servers 130 may also be communicatively coupled with a database 152 that may store data and files associated with the servers 130 and/or the client devices 110.

The network 150 may include a wired network (e.g., via fiber optic or copper wire, telephone lines, and the like) and/or a wireless network (e.g., a satellite network, a cellular network, radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, a laptop computer, a desktop computer, or a mobile device such as a smart phone, a palm device, a tablet device, a television, a wearable device, a display device, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be a computing device such as part of a cloud computing server including one or more desktop computers or panels mounted on racks, and/or the like. The panels may include processing boards and also switchboards, routers, and other network devices. In some embodiments, the servers 130 may include the client devices 110 as well, such that they are peers.

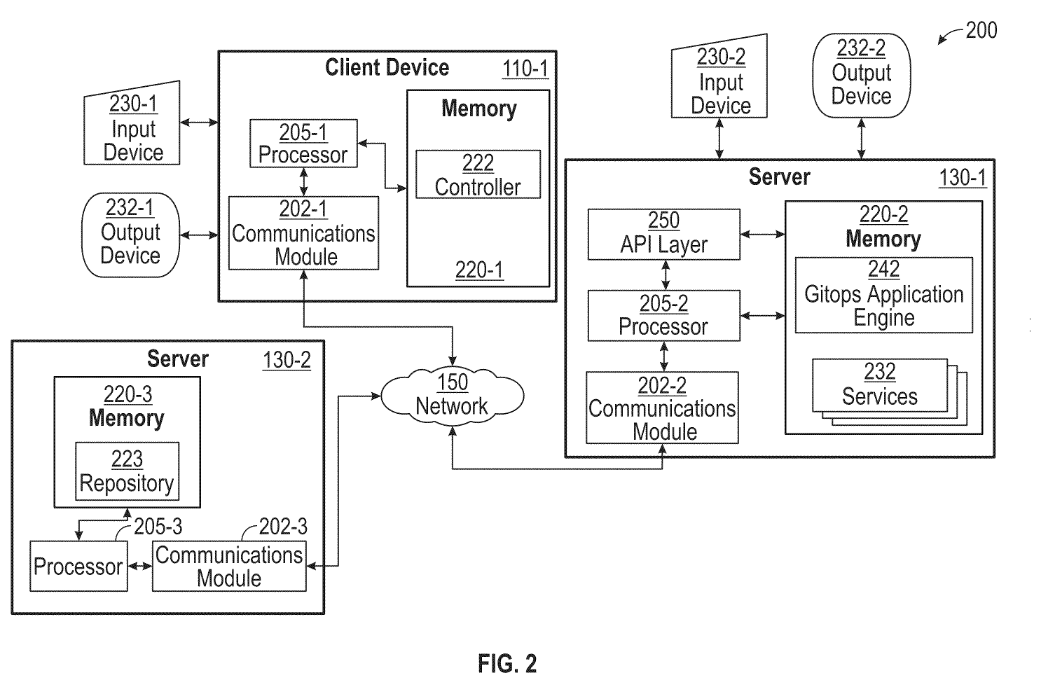

FIG. 2 is a block diagram illustrating details of a system 200 for provisioning virtual datacenters, according to some embodiments. Specifically, the example of FIG. 2 illustrates an exemplary client device 110-1 (of the client devices 110) and an exemplary server 130-1 (of the servers 130) of the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, and commands to other devices on the network 150. Communications modules 202 can be, for example, modems or Ethernet cards, and may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include a controller 222, configured to run in client device 110-1 and couple with input device 230-1 and output device 232-1. The controller 222 may be downloaded by the user from server 130-1, and/or may be hosted by server 130-1. The controller 222 may include specific instructions which, when executed by processor 205-1, cause operations to be performed consistent with embodiments of the present disclosure. In some embodiments, the controller 222 runs on an operating system (OS) installed in client device 110-1. In some embodiments, controller 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

The system 200 further includes a repository 223. In this example, the repository 223 is shown as executing within a memory 220-3 of a server 130-2. The controller 222 may communicate with the repository 223 over network 150. Specifically, the controller 222 may communicate with the repository 223 via a communications module 202-3 of server 130-2. Communications modules 202 may further include communications module 202-3, memories 220 may further include memory 220-3, and processors 205 may further include processor 205-3 of server 130-2.

Various services 233 may execute in memory 220-2 of server 130-1. The controller 222 may communicate with the services 233 over the network 150, e.g., via communications modules 202. Services 233 may include, but are not limited to, container services and cloud services.

In some embodiments, memory 220-2 includes a GitOps application engine 242. The GitOps application engine 242 may be configured to perform methods and operations consistent with embodiments of the present disclosure. The GitOps application engine 242 may share or provide features and resources with the client device, including data, libraries, and/or applications retrieved with GitOps application engine 242 (e.g., controller 222). The user may access the GitOps application engine 242 through the controller 222, installed in memory 220-1 of client device 110-1.

In some embodiments, server 130-1 includes an API layer 250. The controller 222 may communicate with services 233 and/or GitOps application engine 242 through the API layer 250, for example. In addition, the repository 223 may communicate with services 233 and/or GitOps application engine 242 through the API layer 250, for example.

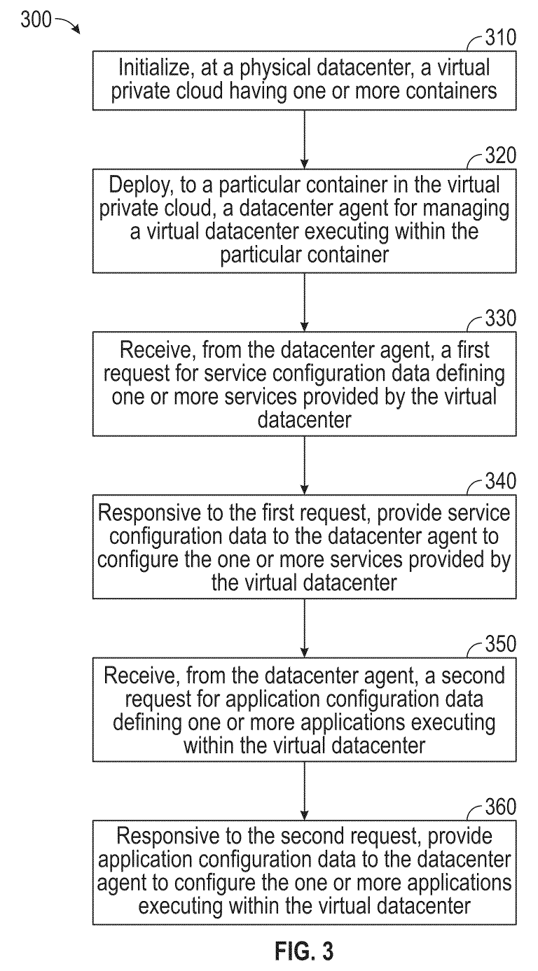

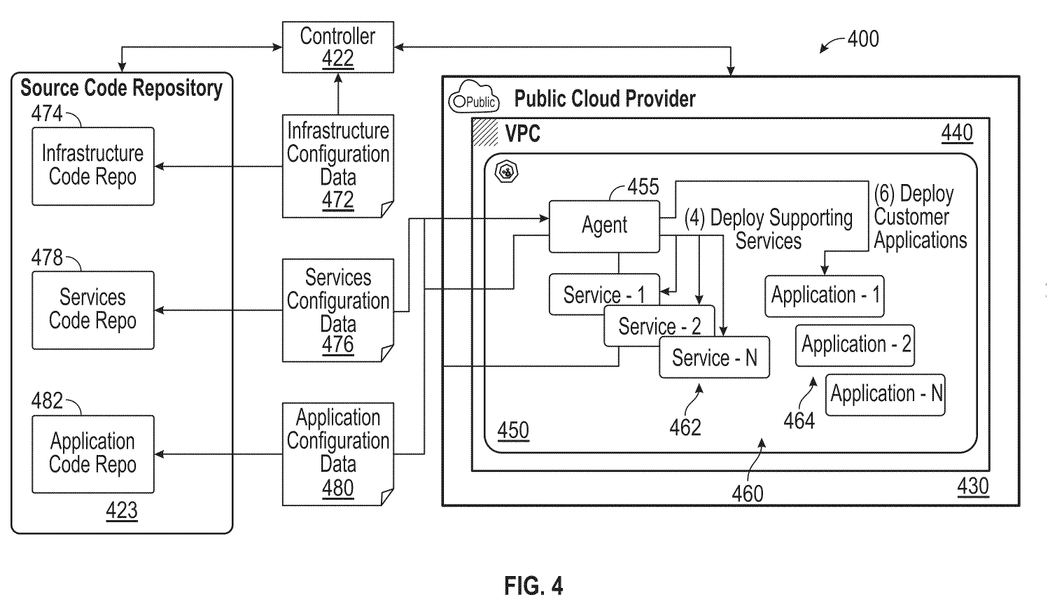

FIG. 3 is a flowchart illustrating a process 300 for virtual datacenter deployment performed by client devices (e.g., client device 110-1, etc.), servers (e.g., server 130-1, server 130-2, etc.), or some combination thereof, according to some embodiments. In some embodiments, one or more operations in process 300 may be performed by a processor (e.g., processors 205, etc.) executing instructions stored in a memory (e.g., memories 220, etc.) of a system (e.g., system 200, etc.) as disclosed herein. For example, operations in process 300 may be performed by controller 222, a GitOps application engine 242, or some combination thereof. Moreover, in some embodiments, a process consistent with this disclosure may include at least operations in process 300 performed in a different order, simultaneously, quasi-simultaneously, or overlapping in time. The process 300 will be discussed with reference to an exemplary example shown in FIG. 4, as described in further detail below.

At 310, the process 300 initializes, at a physical datacenter, a virtual private cloud having one or more containers. The physical datacenter may include servers at multiple geographic locations, and the virtual private cloud may span one or more of those locations. In some embodiments, the physical datacenter is a cloud provider or an on-premises datacenter.

In some embodiments, the physical datacenter may include a cloud management platform. The virtual private cloud may be defined using infrastructure configuration data, and initializing the virtual private cloud at the physical datacenter may include providing the infrastructure configuration data to the cloud management platform to configure the virtual private cloud. The infrastructure configuration data may be retrieved from an infrastructure code repository.

In some embodiments, the virtual private cloud may include a container management platform. The infrastructure configuration data may include container configuration data, and deploying the datacenter agent to the particular container may include providing the container configuration data to the container management platform.

At 320, the process 300 deploys, to a particular container in the virtual private cloud, a datacenter agent for managing a virtual datacenter executing within the particular container.

At 330, the process 300 receives, from the datacenter agent, a first request for service configuration data defining one or more services provided by the virtual datacenter.

At 340, responsive to the first request, the process 300 provides service configuration data to the datacenter agent to configure the one or more services provided by the virtual datacenter. In some embodiments, providing the service configuration data to the datacenter agent may include retrieving the service configuration data from a services code repository.

In some embodiments, the service configuration data configures the virtual datacenter by performing at least one service operation. The service operations may include, but are not limited to, deploying a particular service, initializing the particular service, scheduling the particular service, modifying the particular service, and deleting the particular service.

At 350, the process 300 receives, from the datacenter agent, a second request for application configuration data defining one or more applications executing within the virtual datacenter.

At 360, responsive to the second request, the process 300 provides application configuration data to the datacenter agent to configure the one or more applications executing within the virtual datacenter. In some embodiments, providing the application configuration data to the datacenter agent comprises retrieving the application configuration data from an application code repository.

In some embodiments, the application configuration data configures the virtual datacenter by performing at least one application operation. The application operations may include, but are not limited to, deploying a particular application, initializing the particular application, scheduling the particular application, modifying the particular application, and deleting the particular application.

FIG. 4 is a block diagram illustrating a cloud infrastructure 400 according to some embodiments. The cloud infrastructure includes a controller 422, a source code repository 423, and a public cloud provider 430, that executes a virtual private cloud 440. The virtual private cloud 440 executes at least one container 450.

In the example of FIG. 4, the controller 422 is in communication with the public cloud provider 430 and the source code repository 423. The controller 422 may communicate with a cloud management platform (not shown) of the public cloud provider 430 (e.g., using an API of the public cloud provider 430) to initialize the virtual private cloud 440. The controller 422 may communicate with a container management platform (not shown) of the virtual private cloud 440 to provision container 450 therein.

FIG. 4 further shows a datacenter agent 455 executing within a container 450. The datacenter agent 455 manages a virtual datacenter 460 that provides various services 462 and executes applications 464. In some embodiments, some of the services 462 are provided by the virtual datacenter 460 to some of the applications 464 executing within the virtual datacenter 460.

FIG. 4 further shows the controller 422 retrieving infrastructure configuration data 472 from an infrastructure code repository 474. In this example, the infrastructure code repository 474 is a component of source code repository 423, though in other embodiments the infrastructure code repository 474 may be a separate repository from source code repository 423. The controller 422 uses the infrastructure configuration data 472 to initialize the virtual private cloud 440.

FIG. 4 also shows the datacenter agent 455 retrieving services configuration data 476 from services code repository 478. In this example, the services code repository 478 is a component of source code repository 423, though in other embodiments the services code repository 478 may be a separate repository from source code repository 423. The datacenter agent 455 uses the services configuration data 476 to deploy, manage, and/or configure the services 462.

FIG. 4 also shows the datacenter agent 455 retrieving application configuration data 480 from application code repository 482. In this example, the application code repository 482 is a component of source code repository 423, though in other embodiments the application code repository 482 may be a separate repository from source code repository 423. The datacenter agent 455 uses the application configuration data 480 to deploy, manage, and/or configure the applications 464.

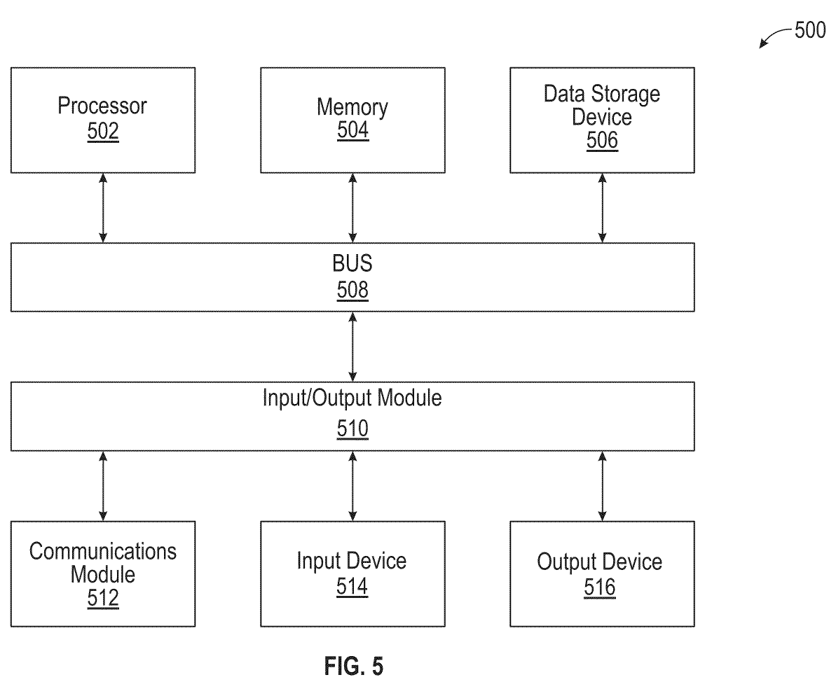

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities. As a non-limiting example, the computer system 500 may be one or more of the servers 130 and/or the client devices 110.

Computer system 500 includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads application data and provides an application, information may be read from the application data and stored in a memory device, such as the memory 504. Additionally, data from the memory 504 servers accessed via a network, the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35U.S.C. § 101, 102, or 103, nor should they be interpreted in such a way.

Embodiments consistent with the present disclosure may be combined with any combination of features or aspects of embodiments described herein.

1. A method for virtual datacenter deployment, comprising:
initializing, at a physical datacenter, a virtual private cloud executing one or more containers;
deploying, to a particular container in the virtual private cloud, a datacenter agent for managing a virtual datacenter executing within the particular container;
receiving, from the datacenter agent, a first request for service configuration data defining one or more services provided by the virtual datacenter;
responsive to the first request, providing the service configuration data to the datacenter agent to configure the one or more services provided by the virtual datacenter;
receiving, from the datacenter agent, a second request for application configuration data defining one or more applications executing within the virtual datacenter; and
responsive to the second request, providing the application configuration data to the datacenter agent to configure the one or more applications executing within the virtual datacenter.

2. The method of claim 1, wherein the physical datacenter is one of a cloud provider or an on-premises datacenter.

3. The method of claim 1, wherein the service configuration data configures the virtual datacenter by performing at least one service operation from a plurality of service operations, the plurality of service operations comprising deploying a particular service, initializing the particular service, scheduling the particular service, modifying the particular service, and deleting the particular service.

4. The method of claim 1, wherein the application configuration data configures the virtual datacenter by performing at least one application operation from a plurality of application operations, the plurality of application operations comprising deploying a particular application, initializing the particular application, scheduling the particular application, modifying the particular application, and deleting the particular application.

5. The method of claim 1, wherein the one or more services are provided by the virtual datacenter to the one or more applications executing within the virtual datacenter.

6. The method of claim 1, wherein the physical datacenter comprises a cloud management platform, and initializing the virtual private cloud at the physical datacenter comprises:
retrieving infrastructure configuration data from an infrastructure code repository, the infrastructure configuration data defining the virtual private cloud; and
providing the infrastructure configuration data to the cloud management platform to configure the virtual private cloud.

7. The method of claim 6, wherein the virtual private cloud comprises a container management platform, the infrastructure configuration data comprises container configuration data, and deploying the datacenter agent to the particular container comprises providing the container configuration data to the container management platform.

8. The method of claim 1, wherein providing the service configuration data to the datacenter agent comprises retrieving the service configuration data from a services code repository.

9. The method of claim 1, wherein providing the application configuration data to the datacenter agent comprises retrieving the application configuration data from an application code repository.

10. A non-transitory computer-readable medium storing a program for virtual datacenter deployment, which when executed by a computer, configures the computer to:
initialize, at a physical datacenter, a virtual private cloud executing one or more containers;
deploy, to a particular container in the virtual private cloud, a datacenter agent for managing a virtual datacenter executing within the particular container;
receive, from the datacenter agent, a first request for service configuration data defining one or more services provided by the virtual datacenter;
responsive to the first request, provide the service configuration data to the datacenter agent to configure the one or more services provided by the virtual datacenter;
receive, from the datacenter agent, a second request for application configuration data defining one or more applications executing within the virtual datacenter; and
responsive to the second request, provide the application configuration data to the datacenter agent to configure the one or more applications executing within the virtual datacenter.

11. The non-transitory computer-readable medium of claim 10, wherein the service configuration data configures the virtual datacenter by performing at least one service operation from a plurality of service operations, the plurality of service operations comprising deploying a particular service, initializing the particular service, scheduling the particular service, modifying the particular service, and deleting the particular service.

12. The non-transitory computer-readable medium of claim 10, wherein the application configuration data configures the virtual datacenter by performing at least one application operation from a plurality of application operations, the plurality of application operations comprising deploying a particular application, initializing the particular application, scheduling the particular application, modifying the particular application, and deleting the particular application.

13. The non-transitory computer-readable medium of claim 10, wherein the physical datacenter comprises a cloud management platform, and initializing the virtual private cloud at the physical datacenter comprises:
retrieving infrastructure configuration data from an infrastructure code repository, the infrastructure configuration data defining the virtual private cloud; and
providing the infrastructure configuration data to the cloud management platform to configure the virtual private cloud.

14. The non-transitory computer-readable medium of claim 13, wherein the virtual private cloud comprises a container management platform, the infrastructure configuration data comprises container configuration data, and deploying the datacenter agent to the particular container comprises providing the container configuration data to the container management platform.

15. The non-transitory computer-readable medium of claim 10, wherein providing the service configuration data to the datacenter agent comprises retrieving the service configuration data from a services code repository.

16. The non-transitory computer-readable medium of claim 10, wherein providing the application configuration data to the datacenter agent comprises retrieving the application configuration data from an application code repository.

17. A system for virtual datacenter deployment, comprising:
a processor; and a non-transitory computer-readable medium storing a set of instructions, which when executed by the processor, configure the system to:
initialize, at a physical datacenter, a virtual private cloud executing one or more containers;
deploy, to a particular container in the virtual private cloud, a datacenter agent for managing a virtual datacenter executing within the particular container;
receive, from the datacenter agent, a first request for service configuration data defining one or more services provided by the virtual datacenter;
responsive to the first request, provide the service configuration data to the datacenter agent to configure the one or more services provided by the virtual datacenter;
receive, from the datacenter agent, a second request for application configuration data defining one or more applications executing within the virtual datacenter; and
responsive to the second request, provide the application configuration data to the datacenter agent to configure the one or more applications executing within the virtual datacenter,
wherein providing the service configuration data to the datacenter agent comprises retrieving the service configuration data from a services code repository, and providing the application configuration data to the datacenter agent comprises retrieving the application configuration data from an application code repository.

18. The system of claim 17, wherein the service configuration data configures the virtual datacenter by performing at least one service operation from a plurality of service operations, the plurality of service operations comprising deploying a particular service, initializing the particular service, scheduling the particular service, modifying the particular service, and deleting the particular service.

19. The system of claim 17, wherein the application configuration data configures the virtual datacenter by performing at least one application operation from a plurality of application operations, the plurality of application operations comprising deploying a particular application, initializing the particular application, scheduling the particular application, modifying the particular application, and deleting the particular application.

20. The system of claim 17, wherein the physical datacenter comprises a cloud management platform, and initializing the virtual private cloud at the physical datacenter comprises:
retrieving infrastructure configuration data from an infrastructure code repository, the infrastructure configuration data defining the virtual private cloud; and
providing the infrastructure configuration data to the cloud management platform to configure the virtual private cloud.
